(19) United States
(12) Patent Application Publication
(10) Pub. No.: US 2026/0117048 A1
(43) Pub. Date: Apr. 30, 2026

(54) MODIFIER FOR POLYAMIDE RESINS AND POLYAMIDE RESIN COMPOSITION

(71) Applicant: KANEKA CORPORATION, Osaka (JP)

(72) Inventor: Yu Suganomata, Takasago-shi (JP)

(73) Assignee: KANEKA CORPORATION, Osaka (JP)

(21) Appl. No.: 19/373,317

(22) Filed: Oct. 29, 2025

(30) Foreign Application Priority Data
Oct. 29, 2024 (JP) 2024189827

(51) Int. Cl. C08K 7/22; C08G 69/08

(52) U.S. Cl. CPC C08K 7/22; C08G 69/08

(57) ABSTRACT

A modifier for polyamide resins that can sufficiently enhance the impact strength of a polyamide resin composition at ambient and low temperatures while minimizing the reduction in melt fluidity of the composition is provided. The modifier for polyamide resins is composed of polymer particles. Each of the polymer particles has a core-shell structure composed of a shell layer and one or more core layers. At least one of the core layers is formed of polybutadiene or poly(butadiene-styrene). The shell layer is formed of a polymer comprising structural units derived from monomer components containing 50 wt % or more of a methacrylic ester monomer and 0 to 50 wt % of another monomer copolymerizable with the methacrylic ester monomer. The polymer particles contain constituent monomer units of maleic anhydride. The amount of the maleic anhydride is from 0.3 to 2.5 wt % based on the total weight of the polymer particles.

### TECHNICAL FIELD

One or more embodiments of the present invention relate to a modifier for polyamide resins and a polyamide resin composition containing the modifier.

### BACKGROUND

A conventionally known technique for improving the impact resistance of a thermoplastic resin is to incorporate a graft copolymer containing a rubber component into the thermoplastic resin.

However, when the thermoplastic resin is a polyamide resin, the rubber-containing graft copolymer is not sufficiently dispersed in the polyamide resin because, in general, polyamide resins and rubber-containing graft copolymers are poorly compatible. Thus, incorporating a rubber-containing graft copolymer into a polyamide resin does not necessarily provide a satisfactory enhancing effect on the impact strength of the polyamide resin. In addition, when the impact strength of a polyamide resin is enhanced by incorporation of a rubber-containing graft copolymer, the resulting composition has low melt fluidity and therefore exhibits poor moldability.

Patent Literature 1 describes a modifier for polyamide resins that can enhance the impact strength of a polyamide resin composition while minimizing the reduction in color developability and fluidity of the composition. The modifier is composed of polymer particles having a core-shell structure and having a specific volume mean diameter. The core layer is formed of polybutadiene or poly(butadiene-styrene), and the shell layer is formed of a polymer containing a specific amount of methacrylic ester monomer. The polymer particles contain a specific amount of carboxyl group-containing vinyl monomer as a constituent monomer.

### PATENT LITERATURE

PTL 1: Japanese Laid-Open Patent Application Publication No. 2021-130777

### SUMMARY

There remains room for improvement in minimizing the reduction in melt fluidity of a polyamide resin composition and in enhancing its impact strength at ambient and low temperatures, particularly at low temperatures. A modifier for polyamide resins that can sufficiently enhance the impact strength of a polyamide resin composition at ambient and low temperatures while minimizing the reduction in melt fluidity of the composition is provided.

One or more embodiments of the present invention relate to a modifier for polyamide resins, the modifier being composed of polymer particles, wherein each of the polymer particles has a core-shell structure composed of a shell layer and one or more core layers, at least one of the core layers is formed of polybutadiene or poly(butadiene-styrene), the shell layer is formed of a polymer comprising structural units derived from monomer components containing 50 wt % or more of a methacrylic ester monomer and 0 to 50 wt % of another monomer copolymerizable with the methacrylic ester monomer, the polymer particles contain constituent monomer units of maleic anhydride, and an amount of the maleic anhydride is from 0.3 to 2.5 wt % based on a total weight of the polymer particles.

One or more embodiments of the present invention can provide a modifier for polyamide resins that can sufficiently enhance the impact strength of a polyamide resin composition at ambient and low temperatures while minimizing the reduction in melt fluidity of the composition.

### DETAILED DESCRIPTION

Hereinafter, one or more embodiments of the present invention will be described in detail.

### (Modifier for Polyamide Resins)

A modifier for polyamide resins according to the present embodiment is composed of polymer particles that are particles of a graft copolymer. Each of the polymer particles has a core-shell structure composed of a shell layer and one or more core layers. The shell layer refers to a polymer layer forming the outer surface of the polymer particle, and is also referred to as a graft layer. The core layer refers to a polymer layer located inside the shell layer in the polymer particle, and is formed of a rubbery polymer. The particle may include only one core layer or may include two or more core layers differing in the compositions of monomers. The shell layer covers the surface of the core layer, but is not limited to covering the entire surface of the core layer and may cover at least a part of the surface of the core layer.

### (Core Layer)

The core layers of the polymer particles are formed of a rubbery polymer. At least one of the core layers may be formed of polybutadiene or poly(butadiene-styrene). All of the core layers may be formed of polybutadiene or poly(butadiene-styrene).

By virtue of the fact that at least one, or preferably all, of the core layers are formed of polybutadiene or poly(butadiene-styrene), the refractive index of the core layers becomes higher and closer to the refractive index of the polyamide resin into which the polymer particles are incorporated than when, for example, acrylic rubber is used as the material of the core layers. Consequently, the visual quality of the resulting polyamide resin composition is improved, and deterioration of the visual quality of the polyamide resin due to incorporation of the polymer particles is minimized. In addition, the polymer particles exhibit a good enhancing effect on the impact strength of the polyamide resin composition at ambient and low temperatures. The visual quality of the polyamide resin composition refers to color developability and gloss. Even when the polymer particles are incorporated into a polyamide resin colored with a colorant containing a coloring ingredient such as carbon black which has a dark color including black, the colored resin can maintain its color developability, avoid an increase in lightness, and retain its gloss.

In order to achieve a good enhancing effect on impact strength at ambient and low temperatures and reduce materials cost, polybutadiene is particularly preferred. The proportion of styrene in poly(butadiene-styrene) is not limited to a particular range, but may be from 0 to 50 wt %. In the present disclosure, the term “ambient temperature” refers to a temperature ranging from about 20 to about 30° C., and the term “low temperature” refers to any temperature lower than the ambient temperature. The “low temperature” may be, for example, −40° C. or higher.

The polybutadiene or poly(butadiene-styrene) may not contain a vinyl monomer other than butadiene and styrene, or may contain such a vinyl monomer. Examples of such a vinyl monomer include: aromatic vinyl monomers such as α-methylstyrene (excluding styrene); (meth)acrylic acids and (meth)acrylic alkyl esters such as acrylic acid, methacrylic acid, ethyl acrylate, butyl acrylate, 2-ethylhexyl acrylate, methyl methacrylate, ethyl methacrylate, butyl methacrylate, 2-hydroxyethyl methacrylate, and glycidyl methacrylate; and unsaturated nitrile monomers such as acrylonitrile and methacrylonitrile.

The polybutadiene or poly(butadiene-styrene) may be produced by polymerization using a polyfunctional monomer such as divinylbenzene, allyl methacrylate, ethylene glycol dimethacrylate, or 1,3-butylene dimethacrylate.

The polybutadiene or poly(butadiene-styrene) may be produced by polymerization without the use of any chain transfer agent, but may be obtained by polymerization in the presence of a chain transfer agent. The use of a chain transfer agent enhances the impact strength of the polyamide resin composition according to the present embodiment at ambient and low temperatures, making it likely that, in impact testing of the composition at ambient and low temperatures, the occurrence of brittle fracture decreases while the occurrence of ductile fracture increases. Examples of chain transfer agents that can be used include, but are not limited to: alkyl mercaptans such as n-dodecyl mercaptan, t-dodecyl mercaptan, 1-decyl mercaptan, n-decyl mercaptan, and n-octyl mercaptan; and alkyl ester mercaptans such as 2-ethylhexyl thioglycolate.

When a chain transfer agent is used, the amount of the chain transfer agent is not limited to a particular range, but may be from 0.01 to 3 wt % based on the total weight of the polybutadiene or poly(butadiene-styrene). When the amount of the chain transfer agent used is within this range, incorporation of the polymer particles into a polyamide resin can provide a stronger enhancing effect on the impact strength of the polyamide resin at ambient and low temperatures. The amount of the chain transfer agent used may be from 0.05 to 2 wt % or from 0.1 to 1 wt %.

The core layers may exhibit a refractive index of 1.50 or more. The use of the core layers with such a refractive index can further improve the visual quality of the polyamide resin composition, thereby further minimizing the deterioration of the visual quality of the polyamide resin due to incorporation of the polymer particles. The refractive index of the core layers may be 1.51 or more or 1.52 or more. The upper limit of the refractive index is not limited to a particular value. For example, the refractive index may be up to 1.58 or up to 1.57.

### (Shell Layer)

The shell layer is formed of a polymer comprising structural units derived from monomer components containing 50 wt % or more of a methacrylic ester monomer and 0 to 50 wt % of another monomer copolymerizable with the methacrylic ester monomer. Being formed of a polymer 50 wt % or more of which is constituted by structural units derived from a methacrylic ester monomer, the shell layer has a high glass transition temperature. Thus, the polymer particles are less likely to become coarse, and a latex of the polymer particles has good mechanical stability. This latex is suitable for industrial production.

Examples of the methacrylic ester monomer used to form the shell layer include, but are not limited to, methacrylic alkyl esters such as methyl methacrylate, ethyl methacrylate, n-butyl methacrylate, i-butyl methacrylate, 1-butyl methacrylate, 2-ethylhexyl methacrylate, octyl methacrylate, dodecyl methacrylate, stearyl methacrylate, and behenyl methacrylate. Among these, methyl methacrylate is preferred. In order to avoid generation of isobutylene gas, which is flammable, during melt processing of the polyamide resin composition, it is preferable not to use 1-butyl methacrylate.

The proportion of the methacrylic ester monomer in the total monomer components used to form the polymer of the shell layer is from 50 to 100 wt %. Since the methacrylic ester monomer accounts for half or more of the shell layer of each polymer particle, the polymer particles are less likely to become coarse in a powder preparation process in which a powder of the polymer particles is obtained from a latex, and thus the resulting polymer particles are uniformly dispersible in the polyamide resin. A further advantage is that a latex of the polymer particles has good mechanical stability. The proportion may be from 60 to 99 wt %, from 70 to 97 wt %, or from 75 to 95 wt %.

The monomer components of the polymer of the shell layer of each polymer particle may include, in addition to the methacrylic ester monomer, another monomer copolymerizable with the methacrylic ester monomer. Such a monomer is not limited to a particular compound, but may be maleic anhydride described later or an acrylic alkyl ester. Examples of the acrylic alkyl ester include methyl acrylate, ethyl acrylate, n-butyl acrylate, i-butyl acrylate, 1-butyl acrylate, 2-ethylhexyl acrylate, octyl acrylate, dodecyl acrylate, stearyl acrylate, and behenyl acrylate. Among these, butyl acrylate is preferred.

The proportion of the other copolymerizable monomer in the total monomer components of the polymer of the shell layer is from 0 to 50 wt %. The proportion may be from 1 to 40 wt %, from 3 to 30 wt %, or from 5 to 25 wt %.

In terms of the compatibility between the polymer particles and the polyamide resin and the enhancing effect on impact strength at ambient and low temperatures, the proportion of the shell layers in the total weight of the polymer particles may be from 1 to 50 wt %, from 5 to 40 wt %, or from 10 to 30 wt %.

### (Maleic Anhydride)

The polymer particles contain constituent monomer units of maleic anhydride. The maleic anhydride may be constituent monomer units of the polymer of the shell layers. In this case, the maleic anhydride may be contained only in the shell layers without being contained in the core layers, or may be contained in both the core layers and the shell layers. It is sufficient that the maleic anhydride be contained in the polymer particles; that is, the maleic anhydride may be contained only in the core layers without being contained in the shell layers.

Since the polymer particles contain the maleic anhydride as a constituent monomer, the impact strength of the polyamide resin composition at ambient and low temperatures can be sufficiently enhanced while minimizing the reduction in melt fluidity of the polyamide resin composition. Furthermore, the maleic anhydride contained in the polymer particles makes the polymer particles reactive with the polyamide resin, thereby improving the dispersibility of the polymer particles in the polyamide resin. It is inferred that the maleic anhydride contained in the polymer particles reacts with the terminal amino groups of the polyamide resin to form an imide having a strong intermolecular force, and that the formation of this imide contributes both to minimizing the reduction in melt fluidity of the polyamide resin composition and to sufficiently enhancing the impact strength of the composition at ambient and low temperatures.

An aspect in which the shell layers contain the maleic anhydride as a constituent monomer is preferred, because in this case the reactivity between the maleic anhydride and the polyamide resin can be significantly enhanced to further improve the dispersibility of the polymer particles in the polyamide resin, thereby further minimizing the reduction in melt fluidity of the polyamide resin composition and further enhancing the impact strength of the composition at ambient and low temperatures.

The amount of the maleic anhydride is from 0.3 to 2.5 wt % based on the total weight of the polymer particles. When the amount of the maleic anhydride is within this range, the impact strength of the polyamide resin composition at ambient and low temperatures can be sufficiently enhanced while minimizing the reduction in melt fluidity of the composition. The lower limit of the proportion may be 0.3 wt %, 0.4 wt %, 0.5 wt %, 0.7 wt %, or 0.8 wt %. The upper limit of the proportion may be 2.5 wt %, 2.2 wt %, 2.0 wt %, 1.7 wt %, or 1.5 wt %.

When the shell layers contain the maleic anhydride as a constituent monomer, the amount of the maleic anhydride in the shell layers may be from 1.5 to 11.5 wt % based on the total weight of the constituent monomers of the polymer of the shell layers. The lower limit of the proportion may be 1.5 wt %, 1.8 wt %, 2.2 wt %, 3.2 wt %, or 3.6 wt %. The upper limit of the proportion may be 11.5 wt %, 10 wt %, 9 wt %, 8 wt %, or 7 wt %.

### (Volume Mean Diameter of Polymer Particles)

In order to achieve stronger impact strength, the volume mean diameter of the polymer particles may be 100 nm or more, 120 nm or more, 140 nm or more, 150 nm or more, 160 nm or more, or 170 nm or more. However, the greater the diameter of the polymer particles, the longer the time required for the polymerization reaction and the lower the productivity. Thus, the volume mean diameter may be 400 nm or less, 350 nm or less, 300 nm or less, 250 nm or less, or 200 nm or less. As described in Examples, the volume mean diameter of the polymer particles is measured for a latex of the polymer particles using a particle size analyzer. Alternatively, the volume mean diameter of the polymer particles can be calculated using a transmission electron microscope (TEM) image of the polyamide resin composition. The diameter of the polymer particles can be controlled by factors such as the type or amount of a polymerization initiator, chain transfer agent, redox agent, or emulsifier, the polymerization temperature, and the polymerization time.

### (Method for Producing Polymer Particles)

The method for producing the polymer particles may be a common method, and is not limited to a particular technique. For example, bulk polymerization, solution polymerization, suspension polymerization, or emulsion polymerization can be used. Emulsion polymerization, in particular emulsion graft polymerization, is preferred. Specifically, in the case of emulsion graft polymerization, a latex of polymer particles corresponding to the core layers is first produced by emulsion polymerization, and then monomer components for forming the shell layers and a polymerization initiator are added to the latex, in which the monomer components are polymerized.

The emulsifier (dispersant) used in emulsion polymerization is not limited to a particular type. For example, an anionic surfactant, a non-ionic surfactant, a cationic surfactant, or an amphoteric surfactant can be used. A dispersant such as polyvinyl alcohol, alkyl-substituted cellulose, polyvinylpyrrolidone, or a polyacrylic acid derivative may be used. Examples of the anionic surfactant used as the emulsifier include, but are not limited to, the following compounds: fatty acid soaps such as potassium laurate, potassium cocoate, potassium myristate, potassium oleate, potassium oleate diethanolamine salt, sodium oleate, potassium palmitate, potassium stearate, sodium stearate, mixed fatty acid sodium soap, partially-hydrogenated tallow fatty acid sodium soap, and castor oil potassium soap; alkyl sulfate salts such as sodium dodecyl sulfate, sodium higher alcohol sulfate, triethanolamine dodecyl sulfate, ammonium dodecyl sulfate, sodium polyoxyethylene alkyl ether sulfate, triethanolamine polyoxyethylene alkyl ether sulfate, sodium polyoxyethylene alkyl phenyl ether sulfate, and sodium 2-ethylhexyl sulfate; sodium alkylbenzenesulfonates such as sodium dodecylbenzenesulfonate; sodium dialkyl sulfosuccinates such as sodium di-2-ethylhexyl sulfosuccinate; sodium alkylnaphthalenesulfonates; sodium alkyl diphenyl ether disulfonates; potassium alkyl phosphates; phosphate salts such as sodium polyoxyethylene lauryl ether phosphate; naphthalenesulfonic acid-formalin condensate sodium salt; polycarboxylic acid-type polymeric anions; sodium acyl (tallow) methyl taurate; sodium acyl (coco) methyl taurate; sodium cocoyl isethionate; α-sulfo fatty acid ester sodium salt; sodium amide ether sulfonate; oleyl sarcosine; sodium lauroyl sarcosinate; and rosin acid soap.

Examples of the non-ionic surfactant used as the emulsifier include, but are not limited to, the following compounds: polyoxyethylene alkyl allyl ethers or polyoxyethylene alkyl ethers such as polyoxyethylene nonyl phenyl ether, polyoxyethylene oleyl ether, and polyoxyethylene lauryl ether; polyoxyethylene sorbitan esters such as polyoxyethylene sorbitan monolaurate and polyoxyethylene sorbitan monostearate; polyoxyethylene fatty acid esters such as polyethylene glycol monolaurate, polyethylene glycol monostearate, and polyethylene glycol monooleate; and oxyethylene/oxypropylene block copolymer.

Examples of the cationic surfactant used as the emulsifier include, but are not limited to, the following compounds: alkylamine salts such as coconut amine acetate, stearylamine acetate, octadecylamine acetate, and tetradecylamine acetate; and quaternary ammonium salts such as lauryl trimethyl ammonium chloride, stearyl trimethyl ammonium chloride, cetyl trimethyl ammonium chloride, distearyl dimethyl ammonium chloride, alkylbenzyl dimethyl ammonium chloride, hexadecyl trimethyl ammonium chloride, and behenyl trimethyl ammonium chloride.

Examples of the amphoteric surfactant used as the emulsifier include, but are not limited to, the following compounds: alkyl betaines such as lauryl betaine, stearyl betaine, and dimethyl lauryl betaine; sodium lauryl diaminoethyl glycine; amide betaine; imidazoline; and lauryl carboxymethyl hydroxyethyl imidazolinium betaine.

One of the emulsifiers (dispersants) mentioned above may be used alone, or two or more thereof may be used in combination. The mean diameter of the polymer particles can be controlled by adjusting the amount(s) of the emulsifier(s) used.

In the case of using emulsion polymerization, a known polymerization initiator such as 2,2′-azobisisobutyronitrile, hydrogen peroxide, potassium persulfate, or ammonium persulfate can be used as a thermally decomposable initiator.

A redox initiator may be used that contains an organic peroxide such as 1-butylperoxyisopropyl carbonate, p-menthane hydroperoxide, cumene hydroperoxide, dicumyl peroxide, 1-butyl hydroperoxide, di-t-butyl peroxide, or 1-hexyl peroxide or an inorganic peroxide such as hydrogen peroxide, potassium persulfate, or ammonium persulfate, optionally in combination with a reducing agent such as sodium formaldehyde sulfoxylate or glucose, further optionally in combination with a transition metal salt such as iron (II) sulfate, further optionally in combination with a chelate agent such as disodium ethylenediaminetetraacetate, and further optionally in combination with a phosphorus-containing compound such as sodium pyrophosphate.

The use of a redox initiator is preferred because, in this case, the polymerization can be carried out at a low temperature at which the peroxide undergoes substantially no thermal decomposition, and the polymerization temperature can be set over a wide range. In particular, an organic peroxide such as cumene hydroperoxide, dicumyl peroxide, or t-butyl hydroperoxide may be used as the redox initiator. The amount of the initiator used may be as known in the art. In the case of using the redox initiator, the amounts of the reducing agent, transition metal salt, and chelate agent may be as known in the art. In the case of polymerization of a monomer having two or more radical-polymerizable double bonds, a known chain transfer agent can be used in an amount as known in the art. A surfactant can be additionally used, and the amount of the surfactant may likewise be as known in the art.

The solvent used in emulsion polymerization may be any solvent in which the emulsion polymerization can proceed stably. For example, water is suitable for use as the solvent.

The temperature during emulsion polymerization is not limited to a particular range, and may be any temperature at which the emulsifier can be uniformly dissolved in the solvent. The temperature may be, for example, from 40 to 75° C., from 45 to 70° C., or from 49 to 65° C.

When the polymer particles are produced by emulsion polymerization, they can be separated from the aqueous medium, for example, as follows: the latex of the polymer particles is mixed with an acid such as hydrochloric acid or a divalent or higher-valent metal salt such as calcium chloride, magnesium chloride, magnesium sulfate, aluminum chloride, or calcium acetate to coagulate the polymer particles; and the polymer particles are then subjected to heat treatment, dehydration, washing, and drying according to known procedures. The obtained polymer particles may be washed with water and/or an organic solvent.

Alternatively, the polymer particles may be isolated as follows: a water-soluble organic solvent is added to the latex of the polymer particles to precipitate the polymer particles; the polymer particles are then separated from the solvent by centrifugation or filtration; and finally the separated polymer particles are dried. The water-soluble organic solvent may be acetone or an alcohol such as methanol, ethanol, or propanol. Another example is a method in which: a slightly water-soluble organic solvent such as methyl ethyl ketone is added to the latex of the polymer particles to extract the polymer particles into an organic solvent layer in the latex; the organic solvent layer is separated; and the organic solvent layer is then mixed with water or the like to precipitate the polymer particles.

Alternatively, the latex of the polymer particles may be directly processed into a powder by spray drying. The obtained powder may be washed with water and/or an organic solvent. Alternatively, a metal salt such as calcium chloride, magnesium chloride, magnesium sulfate, or aluminum chloride may be added, preferably as a solution such as an aqueous solution, to the obtained powder, which may then be dried again as necessary. This treatment provides the same effect as the washing with water and/or an organic solvent.

### (Amount of Modifier)

The modifier for polyamide resins according to the present embodiment, which is composed of the polymer particles detailed above, is used for incorporation into a polyamide resin and has the effect of enhancing the impact strength of the polyamide resin at ambient and low temperatures while minimizing the reduction in melt fluidity of the polyamide resin composition. The amount of the modifier incorporated into the polyamide resin may be set as appropriate. The proportion of the modifier in the total weight of the polyamide resin and the modifier may be from 1 to 40 wt %. When the proportion of the modifier is within this range, the incorporation of the modifier can provide an enhancing effect on the impact strength of the polyamide resin at ambient and low temperatures while keeping the inherent physical properties of the polyamide resin intact and minimizing the reduction in melt fluidity of the polyamide resin composition. The proportion may be from 3 to 30 wt % or from 5 to 25 wt %.

### (Polyamide Resin)

The polyamide resin according to the present embodiment is not limited to a particular type and may be any polymer having an acid amide bond (—CONH—). Examples of such polymers include: a polymer obtained by polycondensation of a diamine with a dibasic acid; a polymer obtained by polycondensation of a diamine derivative such as a diformyl with a dibasic acid; a polymer obtained by polycondensation of a dibasic acid derivative such as a dimethyl ester with a diamine; a polymer obtained by a reaction of a dinitrile or diamide with formaldehyde; a polymer obtained by polyaddition of a diisocyanate with a dibasic acid; a polymer obtained by self-condensation of an amino acid or its derivative; and a polymer obtained by ring-opening polymerization of a lactam. The polyamide resin may contain a polyether block. One polyamide resin may be used alone, or a mixture of two or more polyamide resins may be used.

Specific examples of the polyamide resin include: aliphatic polyamides such as nylon 4, nylon 6, nylon 66, nylon 7, nylon 9, nylon 11, nylon 12, nylon 46, nylon 56, nylon 410, nylon 412, nylon 610, and nylon 612; semi-aromatic polyamides such as nylon 6T, nylon 61, nylon 9T, nylon 10T, nylon M5T, and nylon MXD6; and copolyamides such as nylon 6/66, nylon 6/12, nylon 6/66/12, nylon 6/6T, nylon 66/6T, nylon 6/61, nylon 6T/6I, nylon 6T/12, and nylon 66/6T/6I. Among these, nylon 6, nylon 66, nylon 11, and nylon 12 are preferred in terms of versatility.

### (Another Resin)

The polyamide resin composition according to the present embodiment may not contain a thermoplastic resin other than the polyamide resin, or may contain a thermoplastic resin other than the polyamide resin. When the polyamide resin composition contains a thermoplastic resin other than the polyamide resin, examples of the thermoplastic resin include, but are not limited to, polyethylene, polypropylene, polyvinyl chloride, polystyrene, polyvinyl acetate, polyurethane, polytetrafluoroethylene, ABS resin, AS resin, acrylic resin, polyacetal, polycarbonate, modified polyphenylene ether, polyethylene terephthalate, polybutylene terephthalate, and cyclic polyolefin. The amount of the other thermoplastic resin is not limited to a particular range, but may be, for example, from 0 to 100 parts by weight, from 0 to 50 parts by weight, from 0 to 30 parts by weight, or from 0 to 10 parts by weight per 100 parts by weight of the polyamide resin.

### (Other Additives)

The polyamide resin composition according to the present embodiment may optionally contain additives that can be incorporated into common thermoplastic resin compositions, insofar as the additives do not diminish the effect of one or more embodiments of the present invention. Examples of such additives include, but are not limited to, a colorant, a flame retardant, a flame retardant synergist, an anti-dripping agent, a reinforcing material, a filler, an oxidation inhibitor, a conductive additive, a hydrolysis inhibiter, a thickener, a plasticizer, a lubricant, an antioxidant, an ultraviolet absorber, an antistatic agent, a flow modifier, a mold release agent, a compatibilizer, and a thermal stabilizer.

Examples of the colorant include masterbatches, colored pellets, colored compounds, dry colors, paste colors, and liquid masterbatches. The coloring ingredient contained in the colorant may be, for example, a pigment such as carbon black.

The amount of the coloring ingredient may be set as appropriate. In order to achieve good color development with an efficient usage amount, the amount of the coloring ingredient may be from 0.1 to 3 parts by weight, from 0.1 to 2 parts by weight, or from 0.5 to 1.5 parts by weight per 100 parts by weight of the polyamide resin composition.

In order to enhance impact strength at ambient and low temperatures, the polyamide resin composition according to the present embodiment may further contain a reinforcing material. Examples of the reinforcing material include glass fibers, carbon fibers, boron fibers, asbestos fibers, polyvinyl alcohol fibers, polyester fibers, acrylic fibers, fully aromatic polyamide fibers, polybenzoxazole fibers, polytetrafluoroethylene fibers, kenaf fibers, bamboo fibers, hemp fibers, bagasse fibers, high-strength polyethylene fibers, alumina fibers, silicon carbide fibers, potassium titanate fibers, brass fibers, stainless steel fibers, steel fibers, ceramic fibers, and basalt fibers. Among these, glass fibers, carbon fibers, and metal fibers are preferred because these fibers have a good enhancing effect on impact strength. Glass fibers are more preferred. One reinforcing material may be used alone, or two or more reinforcing materials may be used in combination.

The amount of the reinforcing material may be set as appropriate. In order to enhance impact strength with an efficient usage amount, the amount of the reinforcing material may be from 1 to 50 parts by weight, from 10 to 40 parts by weight, or from 25 to 35 parts by weight per 100 parts by weight of the polyamide resin composition.

### (Method for Producing Composition)

The method used to produce the polyamide resin composition according to the present embodiment is not limited to a particular technique, and may be a common method for producing a thermoplastic resin composition. For example, the polyamide resin composition can be obtained by mixing raw materials using a Henschel mixer or a tumbler mixer and then melting and kneading the mixture. The melting and kneading can be carried out using a kneading device such as a single-screw or twin-screw extruder, a Banbury mixer, a pressure kneader, or a mixing roll mill. Through this melting and kneading, pellets composed of the polyamide resin composition can be produced.

The polyamide resin composition according to the present embodiment can be molded into a molded article having a given shape. The molding method used is not limited to a particular technique, and may be, for example, injection molding, extrusion molding, blow molding, calender molding, blown film molding, rotational molding, or press molding.

### (Applications)

The polyamide resin composition according to the present embodiment and its molded article can be used in various applications by taking advantage of their properties such as being oil resistant, being electrically non-conductive, and having good color developability without surface coating. Examples of the applications include, but are not limited to: automotive products such as cylinder head covers, engine covers, intake manifolds, radiator tanks, oil pans, accelerator pedals, canisters, fuel tubes, air brake tubes, exhaust gas tubes, hydrogen injectors, ducts, industrial fasteners, and door mirror stays; electric/electronic products such as coil bobbins, connectors, gears, sockets, switches, sheathed wires for electric blankets, sheath materials for optical fiber cables, electric tools, electric wire bundling materials, and chargers; mechanical products such as hydraulic or pneumatic connectors or tubes, covers, housings, bearings, pressure-resistant hoses, and bundling bands; building products such as curtain rail parts, aluminum sash corners, door rollers, handrails, curtain rollers, and door handles; sports/leisure products such as sport shoe soles, goods for ski or snowboarding, reels, and diving snorkels; package/container products such as shrink packaging films, food packaging films, alcoholic beverage bottles, and agricultural chemical bottles; daily-use products such as toothbrushes, legs and armrests of chairs, combs, knives, and forks; and medical products such as medical catheters or pipes, medical packs, and surgical sutures.

In the following items, preferred aspects of the present disclosure are listed. The present invention is not limited to the following items.

### Item 1

A modifier for polyamide resins, being composed of polymer particles, wherein
each of the polymer particles has a core-shell structure composed of a shell layer and one or more core layers,
at least one of the core layers is formed of polybutadiene or poly (butadiene-styrene),
the shell layer is formed of a polymer comprising structural units derived from monomer components containing 50 wt % or more of a methacrylic ester monomer and 0 to 50 wt % of another monomer copolymerizable with the methacrylic ester monomer,
the polymer particles contain constituent monomer units of maleic anhydride, and
an amount of the maleic anhydride is from 0.3 to 2.5 wt % based on a total weight of the polymer particles.

### Item 2

The modifier for polyamide resins according to item 1, wherein the polymer of the shell layer comprises the constituent monomer units of the maleic anhydride.

### Item 3

The modifier for polyamide resins according to item 1 or 2, wherein the core layers exhibit a refractive index of 1.50 or more.

### Item 4

The modifier for polyamide resins according to any one of items 1 to 3, wherein the polymer particles have a volume mean diameter of 100 nm or more.

### Item 5

The modifier for polyamide resins according to any one of items 1 to 4, wherein a proportion of the shell layers of the polymer particles in a total weight of the polymer particles is from 1 to 50 wt %.

### Item 6

A polyamide resin composition containing:
a polyamide resin; and
the modifier for polyamide resins according to any one of items 1 to 5, wherein
a proportion of the modifier in a total weight of the polyamide resin and the modifier is from 1 to 40 wt %.

### Item 7

The polyamide resin composition according to item 6, further containing 0.1 to 3 parts by weight of a coloring ingredient per 100 parts by weight of the polyamide resin composition.

### Item 8

The polyamide resin composition according to item 6 or 7, further containing 1 to 50 parts by weight of a reinforcing material per 100 parts by weight of the polyamide resin composition.

### Item 9

Pellets composed of the polyamide resin composition according to any one of items 6 to 8.

### Item 10

A molded article composed of the polyamide resin composition according to any one of items 6 to 8.

### EXAMPLES

Hereinafter, one or more embodiments of the present invention will be described in more detail using examples. The present invention is not limited to the examples described below.

### (Refractive Index of Core Layers)

The refractive index of core layers was measured according to JIS K 7142 using Abbe Refractometer 2T manufactured by Atago Co., Ltd.

### (Mean Diameter of Polymer Particles)

The volume mean diameter of polymer particles was measured for a latex of the polymer particles. The measurement device used was Nanotrac Wave manufactured by Nikkiso Co., Ltd.

### (Polymerization Conversion Rate)

Part of the obtained polymer particle latex was sampled and accurately weighed. The sample was dried in a hot air dryer at 120° C. for 1 hour, and the weight of the dried sample was accurately measured as solids weight. Subsequently, the ratio of the weight measured after drying to the weight measured before drying was determined as the solids ratio in the latex. Finally, the solids ratio was used to calculate the polymerization conversion rate by the following equation.

Polymerization conversion rate=(Total weight of raw materials used×solids ratio-total weight of raw materials other than monomers)/weight of monomers used×100(%) Equation:

### <Method for Producing Core Layers>

A pressure-resistant polymerization reactor was charged with 170 parts by weight of deionized water, 0.002 parts by weight of disodium ethylenediaminetetraacetate, 0.0012 parts by weight of iron (II) sulfate heptahydrate, and 0.13 parts by weight of sodium dodecylbenzenesulfonate, and the contents of the reactor were thoroughly degassed under stirring to remove oxygen. Subsequently, 100 parts by weight of butadiene (hereinafter abbreviated as “BD”) was added to the reaction system, which was then heated to 45° C. To the heated system, 0.05 parts by weight of sodium formaldehyde sulfoxylate and 0.03 parts by weight of p-menthane hydroperoxide were added to initiate polymerization. Six, 10, 14, and 17 hours after the start of polymerization, 0.014 parts by weight of p-menthane hydroperoxide was added. Twenty hours after the start of polymerization, residual monomers were removed by evaporation under reduced pressure to terminate the polymerization. As a result, a polybutadiene rubber latex (core layers) containing polybutadiene rubber as a main component was obtained. The volume mean diameter of the polybutadiene rubber particles in the obtained latex was adjusted as appropriate by varying the amount of sodium dodecylbenzenesulfonate initially added.

Procedures for producing a polymer particle latex of Example 1 will be described as a typical method for producing a polymer particle latex. Polymer particle latexes of Examples other than Example 1 and those of Comparative Examples were also produced according to the production procedures described below for Example 1, except that the compositions of shell layer-forming monomers were changed as shown in the table below.

### <Shell Layer Production Method in Example 1>

A glass reactor equipped with a thermometer, a stirrer, a reflux condenser, a nitrogen inlet, and a device for adding monomers and emulsifiers was charged with 30 parts by weight of deionized water and 78 parts by weight (solids weight) of the polybutadiene rubber latex (core layers) described above, and the contents of the reactor were heated to 60° C. under stirring in a stream of nitrogen. Next, 0.00032 parts by weight of disodium ethylenediaminetetraacetate, 0.00008 parts by weight of iron (II) sulfate heptahydrate, and 0.04 parts by weight of sodium formaldehyde sulfoxylate were introduced into the reactor. After that, a mixture of 19.4 parts by weight of methyl methacrylate (hereinafter abbreviated as “MMA”), 2.2 parts by weight of n-butyl acrylate (hereinafter abbreviated as “BA”), 0.5 parts by weight of maleic anhydride (hereinafter abbreviated as “MAH”), and 0.024 parts by weight of t-butyl hydroperoxide was added over 68 minutes. Five minutes after completion of addition of the mixture, sodium formaldehyde sulfoxylate and t-butyl hydroperoxide were further added as appropriate to obtain a polymer particle latex (shell layers) at a polymerization conversion rate of 100%.

### (Obtainment of White Resin Powder of Polymer Particles in Examples and Comparative Examples)

A mixture of 760 parts by weight of deionized water and 3.3 parts by weight of a 25 wt % aqueous solution of calcium chloride was heated to 60° C. under stirring. The polymer particle latex, to which 2.5 parts by weight of a hindered phenol antioxidant, IRGANOX 1076 (n-octadecyl-3-(3′,5′-di-t-butyl-4′-hydroxyphenyl) propionate), had been added, was introduced into the heated mixture to obtain a slurry containing coagulated latex particles. Subsequently, the slurry was heated to 90° C. for dehydration and drying to obtain a white resin powder of polymer particles.

### (Production of Polyamide Resin Composition)

Pellets and test specimens formed of a composition containing a polyamide resin and a white resin powder of polymer particles were prepared according to the procedures described below, and these samples were tested for Izod impact strength, MFR, isobutylene gas generation, and L value and gloss as indicators of visual quality. The results are shown in the table below. In Reference Example 1, the white resin powder of polymer particles was not used. In Comparative Example 7, a commercially-available modifier was used instead of the white resin powder of polymer particles.

### (Conditions for Preparation of Pellets and Test Specimens)

### Examples and Comparative Examples

(a) 79.5 parts by weight of nylon 6 (polyamide 6 resin, UBE 1030B manufactured by UBE Corporation)
(b) 20 parts by weight of polymer particles or commercially-available modifier
(c) 0.5 parts by weight of carbon black

### Reference Example

(a) 99.5 parts by weight of nylon 6 (polyamide 6 resin, UBE 1030B manufactured by UBE Corporation
(c) 0.5 parts by weight of carbon black

A mixture of the components (a), (b), and (c), or a mixture of the components (a) and (c), was placed into a twin-screw extruder (TEX 44SS manufactured by The Japan Steel Works, Ltd.) whose barrel temperature was heated to 210 to 270° C., and the mixture was kneaded at a screw rotational speed of 200 rpm and extruded to obtain pellets.

The pellets were dried using a vacuum dryer at 120° C. for 12 hours to fully reduce their moisture content. The dried pellets were processed using an injection molding machine (FAS 100B manufactured by Fanuc Corporation) at a molding temperature of 270° C. and a mold temperature of 80° C. to prepare test specimens.

### (Izod Impact Strength)

Test Specimen 1, a 4.0-mm-thick V-notched specimen prepared as described above, was brought into an absolutely dry state and tested for Izod impact strength at −30° C. and 23° C. according to ASTM D256.

### (MFR)

The pellets prepared under the conditions described above were dried using a vacuum dryer at 120° C. for 12 hours, after which the pellets were tested for MFR at a measurement temperature of 270° C. and a load of 5 kg according to the method A of JIS K 7210.

### (Isobutylene Gas Generation)

While the polyamide resin and the polymer particles were kneaded under the conditions described above, gas was extracted through a vent. The gas was analyzed using a GCMS (Trace 1300-ISQ-QD manufactured by Thermo Fisher Scientific) to determine whether isobutylene gas was present.

### (L Value)

A 2-mm-thick colored plate was obtained under the same conditions as the test specimen for Izod impact strength was prepared. The colored plate obtained was tested for reflectance L value using a color-difference meter manufactured by Nippon Denshoku Industries Co., Ltd. (Model ZE 6000) according to JIS Z 8741. A lower L value indicates a darker black color and better color developability.

### (Gloss)

A 2-mm-thick colored plate was obtained under the same conditions as the test specimen for Izod impact strength was prepared. The colored plate obtained was tested for 60° specular gloss using a color-difference meter manufactured by Nippon Denshoku Industries Co., Ltd. (Model VG 7000) according to JIS K 8722.

TABLE 1

| No. | | | | | Ref. 1 | Comp. 1 | Comp. 2 | Comp. 3 | Comp. 4 | Comp. 5 | Comp. 6 |
|---|---|---|---|---|---|---|---|---|---|---|---|
| Polymer | Core | Type of monomer | | | — | Butadiene (BD) | | | | | |
| particles | layer | Parts by weight | | | — | 78 | | | | | |
| | | Refractive index | | | — | 1.515 | 1.515 | 1.515 | 1.515 | 1.515 | 1.515 |
| | Shell | Types of | MMA | Parts by | — | 19.8 | 15.8 | 19.6 | 14.9 | 19.6 | 17.1 |
| | layer | monomers | | weight | | | | | | | |
| | | | BA | Parts by | — | 2.2 | 1.8 | 2.2 | 1.7 | 2.2 | 1.9 |
| | | | | weight | | | | | | | |
| | | | t-BMA | Parts by | — | | 4.5 | | | | |
| | | | | weight | | | | | | | |
| | | | MAA | Parts by | — | | | 0.2 | | | |
| | | | | weight | | | | | | | |
| | | | HEMA | Parts by | — | | | | 5.5 | | |
| | | | | weight | | | | | | | |
| | | | MAH | Parts by | — | | | | | 0.2 | 3 |
| | | | | weight | | | | | | | |

| | | | | | | | |
|---|---|---|---|---|---|---|---|
| Amount of MAH/Total | — | — | — | — | — | 0.2 | 3 |
| weight of polymer | | | | | | | |
| particles (wt %) | | | | | | | |

| | | |
|---|---|---|
| Volume mean diameter (nm) | — | 180 |

| Polyamide resin | UBE | Parts by | 99.5 | 79.5 | 79.5 | 79.5 | 79.5 | 79.5 | 79.5 |
|---|---|---|---|---|---|---|---|---|---|
| | 1030B | weight | | | | | | | |
| Core-shell polymer particles | | Parts by | — | 20.0 | 20.0 | 20.0 | 20.0 | 20.0 | 20.0 |
| | | weight | | | | | | | |
| Coloring ingredient | Carbon | Parts by | 0.5 | 0.5 | 0.5 | 0.5 | 0.5 | 0.5 | 0.5 |
| | black | weight | | | | | | | |
| Izod impact strength | 23° C. | kJ/m² | 3.4 | 8.7 | 85.0 | 87.0 | 70.0 | 79.0 | 81.0 |
| (notched specimen) | −30° C. | | 1.9 | 4.2 | 61.0 | 30.0 | 7.0 | 41.0 | 52.0 |
| MFR | 5.0 kg | cm³/10 | 27.3 | 10.0 | 1.0 | 1.4 | 7.3 | 11.2 | 7.2 |
| | 270° C. | min. | | | | | | | |

| Isobutylene gas generation | | None | None | Occurred | None | None | None | None |
|---|---|---|---|---|---|---|---|---|
| Visual quality | L value | 5.6 | 5.6 | 5.9 | 5.9 | 6.1 | 5.6 | 5.6 |
| | Gloss | 101 | 99 | 98 | 98 | 96 | 99 | 97 |

| | | | | | | | |
|---|---|---|---|---|---|---|---|
| No. | Comp. 7 | Ex. 1 | Ex. 2 | Ex. 3 | Ex. 4 | Ex. 5 | Ex. 6 |

| | | | | |
|---|---|---|---|---|
| Polymer | Core | Type of monomer | MH7020 | Butadiene (BD) |
| particles | layer | Parts by weight | | 78 |

| | Refractive index | | | 1.515 | 1.515 | 1.515 | 1.515 | 1.515 | 1.515 |
|---|---|---|---|---|---|---|---|---|---|
| Shell | Types of | MMA | Parts by | 19.4 | 18.9 | 18.5 | 18.0 | 18.9 | 18.9 |
| layer | monomers | | weight | | | | | | |
| | | BA | Parts by | 2.2 | 2.1 | 2.1 | 2.0 | 2.1 | 2.1 |
| | | | weight | | | | | | |
| | | t-BMA | Parts by | | | | | | |
| | | | weight | | | | | | |
| | | MAA | Parts by | | | | | | |
| | | | weight | | | | | | |
| | | HEMA | Parts by | | | | | | |
| | | | weight | | | | | | |
| | | MAH | Parts by | 0.5 | 1 | 1.5 | 2 | 1 | 1 |
| | | | weight | | | | | | |

| | | | | | | |
|---|---|---|---|---|---|---|
| Amount of MAH/Total | 0.5 | 1 | 1.5 | 2 | 1 | 1 |
| weight of polymer | | | | | | |
| particles (wt %) | | | | | | |

| | | | |
|---|---|---|---|
| Volume mean diameter (nm) | 180 | 140 | 230 |

| Polyamide resin | UBE | Parts by | 79.5 | 79.5 | 79.5 | 79.5 | 79.5 | 79.5 | 79.5 |
|---|---|---|---|---|---|---|---|---|---|
| | 1030B | weight | | | | | | | |
| Core-shell polymer particles | | Parts by | 20.0 | 20.0 | 20.0 | 20.0 | 20.0 | 20.0 | 20.0 |
| | | weight | | | | | | | |
| Coloring ingredient | Carbon | Parts by | 0.5 | 0.5 | 0.5 | 0.5 | 0.5 | 0.5 | 0.5 |
| | black | weight | | | | | | | |
| Izod impact strength | 23° C. | kJ/m² | 83.0 | 104.0 | 109.0 | 105.0 | 102.0 | 105.0 | 109.0 |
| (notched specimen) | −30° C. | | 59.6 | 68.0 | 78.0 | 73.0 | 71.0 | 70.5 | 81.1 |
| MFR | 5.0 kg | cm³/10 | 2.1 | 10.0 | 9.3 | 8.6 | 8.2 | 9.0 | 9.9 |

| | |
|---|---|
| 270° C. | min. |

| Isobutylene gas generation | | None | None | None | None | None | None | None |
|---|---|---|---|---|---|---|---|---|
| Visual quality | L value | 6.9 | 5.6 | 5.6 | 5.6 | 5.6 | 5.6 | 5.6 |

| | | | | | | | |
|---|---|---|---|---|---|---|---|
| Gloss | 72 | 99 | 99 | 99 | 99 | 98 | 100 |

Abbreviations used in Table 1 to refer to shell layer-forming monomers other than MMA, BA, and MAH, and the details of the modifier used in Comparative Example 7, are as follows.
t-BMA: t-Butyl methacrylate
MAA: Methacrylic acid
HEMA: 2-Hydroxyethyl methacrylate
MH7020: TAFMER MH7020 (α-olefin copolymer), manufactured by Mitsui Chemicals, Inc.

Compared to the composition of Reference Example 1 which did not contain any polymer particles, the polyamide resin composition of Comparative Example 1, which incorporated polymer particles containing no maleic anhydride, showed little increase in impact strength at ambient and low temperatures, although the reduction in melt fluidity was minimized.

The polyamide resin compositions of Comparative Examples 2 and 3, each of which incorporated polymer particles containing no maleic anhydride but containing 1-BMA or MAA as a constituent monomer, exhibited a greater increase in impact strength at ambient and low temperatures than the composition of Comparative Example 1, but failed to avoid a significant reduction in melt fluidity. Furthermore, in Comparative Example 2, isobutylene gas, which is flammable, was generated during kneading of the polyamide resin and the polymer particles.

The polyamide resin composition of Comparative Example 4, which incorporated polymer particles containing no maleic anhydride but containing HEMA as a constituent monomer, exhibited a greater increase in impact strength at ambient temperature than the composition of Comparative Example 1. However, the increase in impact strength at low temperature was small, and the reduction in melt fluidity was not sufficiently minimized.

The polyamide resin composition of Comparative Example 5, which incorporated polymer particles containing maleic anhydride as a constituent monomer in an amount below the specified range, showed only a minimal reduction in fluidity, and exhibited a greater increase in impact strength at ambient and low temperatures than the composition of Comparative Example 1. However, the increase was still unsatisfactory.

The polyamide resin composition of Comparative Example 6, which incorporated polymer particles containing maleic anhydride as a constituent monomer in an amount above the specified range, exhibited a greater increase in impact strength at room and low temperatures than the composition of Comparative Example 1, but the increase in impact strength was still unsatisfactory. In addition, the reduction in fluidity was not sufficiently minimized.

The polyamide resin composition of Comparative Example 7, in which a commercially-available modifier was used instead of the white resin powder of polymer particles, exhibited a greater increase in impact strength at room and low temperatures than the composition of Comparative Example 1, but underwent a significant reduction in fluidity. Furthermore, the incorporation of the modifier led to the composition having a high L value and being inferior in color developability and gloss.

In contrast, the polyamide resin compositions of Examples 1 to 6, each of which incorporated polymer particles containing maleic anhydride as a constituent monomer in an amount within the specified range, exhibited high impact strength at ambient and low temperatures and showed only a minimal reduction in fluidity. Furthermore, isobutylene gas was not generated, and the compositions exhibited high visual quality, as demonstrated by their L values and gloss comparable to those of the composition of Reference Example 1.

The results discussed above reveal that, compared to the polymer particles of Comparative Examples 1 to 7, the polymer particles of Examples 1 to 6 can significantly enhance the impact strength of polyamide resin compositions at ambient and low temperatures while minimizing the reduction in melt fluidity of the compositions. It is also evident that the polymer particles of Example 1 to 6 do not impair the high visual quality of the polyamide resin compositions.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A modifier for polyamide resins, comprising polymer particles, wherein
each of the polymer particles comprises a core-shell structure comprising a shell layer and one or more core layers,
at least one of the core layers comprises polybutadiene or poly (butadiene-styrene),
the shell layer comprises a polymer comprising structural units derived from monomer components containing 50 wt % or more of a methacrylic ester monomer and 0 to 50 wt % of another monomer copolymerizable with the methacrylic ester monomer,
the polymer particles comprise constituent monomer units of maleic anhydride, and
an amount of the maleic anhydride is from 0.3 to 2.5 wt % based on a total weight of the polymer particles.

2. The modifier according to claim 1, wherein the polymer of the shell layer comprises the constituent monomer units of the maleic anhydride.

3. The modifier according to claim 1, wherein the core layers exhibit a refractive index of 1.50 or more.

4. The modifier according to claim 1, wherein the polymer particles have a volume mean diameter of 100 nm or more.

5. The modifier according to claim 1, wherein a proportion of the shell layers of the polymer particles in a total weight of the polymer particles is from 1 to 50 wt %.

6. A polyamide resin composition comprising:
a polyamide resin; and
the modifier for polyamide resins according to claim 1, wherein
a proportion of the modifier in a total weight of the polyamide resin and the modifier is from 1 to 40 wt %.

7. The polyamide resin composition according to claim 6, further comprising 0.1 to 3 parts by weight of a coloring ingredient per 100 parts by weight of the polyamide resin composition.

8. The polyamide resin composition according to claim 6, further comprising 1 to 50 parts by weight of a reinforcing material per 100 parts by weight of the polyamide resin composition.

9. Pellets comprising the polyamide resin composition according to claim 6.

10. A molded article comprising the polyamide resin composition according to claim 6.

11. The modifier according to claim 2, wherein the core layers exhibit a refractive index of 1.50 or more.

12. The modifier according to claim 2, wherein the polymer particles have a volume mean diameter of 100 nm or more.

13. The modifier according to claim 2, wherein a proportion of the shell layers of the polymer particles in a total weight of the polymer particles is from 1 to 50 wt %.

14. A polyamide resin composition comprising:
a polyamide resin; and
the modifier for polyamide resins according to claim 2, wherein
a proportion of the modifier in a total weight of the polyamide resin and the modifier is from 1 to 40 wt %.

15. The polyamide resin composition according to claim 14, further comprising 0.1 to 3 parts by weight of a coloring ingredient per 100 parts by weight of the polyamide resin composition.

16. The polyamide resin composition according to claim 14, further comprising 1 to 50 parts by weight of a reinforcing material per 100 parts by weight of the polyamide resin composition.

17. Pellets comprising the polyamide resin composition according to claim 14.

18. A molded article comprising the polyamide resin composition according to claim 14.
